(19) United States
(12) Patent Application Publication
(10) Pub. No.: US 2022/0229834 A1
(43) Pub. Date: Jul. 21, 2022

(54) SEARCHING DRIVER INFORMATION SYSTEMS OF A VEHICLE

(71) Applicant: Volkswagen Aktiengesellschaft, Wolfsburg (DE)

(72) Inventors: Heino Wengelnik, Wolfsburg (DE); Martin Feder, Adenbüttel (DE); Dominic Wäsch, Leiferde (DE)

(21) Appl. No.: 17/608,425

(22) PCT Filed: Apr. 8, 2020
(86) PCT No.: PCT/EP2020/059976

§ 371 Date: Nov. 2, 2021

(30) Foreign Application Priority Data
May 2, 2019 (DE) 10 2019 206 310.1

(51) Int. Cl. G06F 16/248; G06F 16/2457; G06F 16/26

(52) U.S. Cl. CPC G06F 16/248; G06F 16/26; G06F 16/24578

(57) ABSTRACT

A driver information system for a vehicle, having a display device by means of which a graphical user interface can be displayed. The graphical user interface includes links to services, and the services can be displayed on the display device when an associated link is actuated. The driver information system (includes a main search function that is configured to determine, according to a search input, search results both of the graphical user interface and of the services. A method for searching a driver information system of a vehicle is also disclosed.

### CROSS REFERENCE TO RELATED APPLICATION

The present application claims priority to International Patent App. No. PCT/EP2020/059976 to Wengelnik, et al., titled Searching Driver Information Systems of a Vehicle”, filed Apr. 8, 2020, which claims priority to German Patent App. No 10 2019 206 310.1, filed May 2, 2019, the contents of each being incorporated by reference in their entirety herein.

### FIELD OF TECHNOLOGY

The present disclosure relates to a driver information system for a vehicle and a method for searching through a driver information system. The driver information system can also be referred to as an infotainment system, or include infotainment functions. It can be permanently installed, or provided, in a vehicle interior.

### BACKGROUND

Driver information systems allow a driver, or any other occupant in the vehicle, to access various information and functions. Such systems typically include a display unit, preferably including a touch-sensitive surface for user input. User input can also be entered in the form of speech commands, gesture recognition, or via a separate control element (e.g. a switch, rotary knob, touchpad, or lever).

The driver information systems also include (graphical) user interfaces that can function as (virtual) work surfaces and/or as higher-order file managers and/or as a so-called desk environment. In particular, the graphical user interface can include a so-called home-screen, which can also be described as a main screen or start screen. This can be shown automatically after completing a start-up process for the driver information system, and preferably without further user input. It is also preferred that the user can always return to this start-up screen after inputting a specific command and in particular so-called shortcuts (i.e., an input that shortens the normal operating sequence). Additionally or alternatively, this can be lowest level of screen that can be shown with the driver information system, which can be called up via the user interface, and via which a user can navigate the system.

The graphical user interface can be designed as a software application or software component, and/or form a service for the driver information system.

Driver information systems normally include numerous services. These can be selected or activated by a user via the graphical user interface. The user can actuate links for this, which are displayed within the graphical user interface (e.g., by clicking or tapping). These services can then preferably be displayed on the display unit in the foreground and/or at the front. In particular, the screen on the display unit can switch from that of the graphical interface to a screen for the service.

When a service is referred to below, this is preferably a software application and/or software application other than the graphical user interface, which could be referred to according to the explanations above, but also in principle, as a service of the driver information system.

The services can each provide specific functions and/or be provided for certain needs of the driver. Examples of services include a navigation service, music playback service, radio service, (digital) vehicle owner's manual, or (digital) address book.

Each service can include numerous screens, input options, information or general data that can be displayed. The data in a service can be stored locally or be available online, for example. These services can also include search functions (with the exception of the user interface itself), for helping the user find the content or data in this service that is of interest. By way of example, a navigation service can include search functions for addresses, so-called points of interest, or favorite or previous destinations. A music playback service can likewise search through titles, e.g., in a data base for this service.

Because of the numerous services that can be accessed, a great deal of content can also be accessed via the driver information system. The user interface itself can also include a great deal of content, such as input options and functions, due to the complex menu structures. It may be difficult for a user to quickly and easily get oriented within the content that can be accessed via the driver information system. By way of example, it may not always be apparent which service provides a certain function or input option. With the prior art, a type of iterative approach or, in general, an iterative search for the desired content within the driver information system may be necessary. This can be more distracting that one would desire.

### SUMMARY

Aspects of the present disclosure are therefore to improve the operating convenience of vehicle driver information systems, in particular to minimize driver distractions.

These aspects are disclosed in the independent claims provided herein. Other advantageous aspects are provided in the dependent claims. It should be understood that all of the introductory features, developments, variations and embodiments likewise relate to the solution according to the present disclosure, or can be included therein, if not otherwise specified or apparent.

In general, the present disclosure discloses a main search function, which can also be referred to as a global search function. Consequently, searching is not limited to individual services. Instead, numerous services can be searched through in parallel, such that it is possible to search for results on a global level.

The graphical user interface disclosed herein is also advantageously searched for relevant results. As a result, corresponding input functions can also be displayed as search results to a user searching, e.g., for a certain setting option (e.g., temperature control or volume control), which can then be accessed via the graphical user interface itself. This differs from previous approaches in which a user may need to first know the relevant service for such a setting, and then to search for the desired input option within this service. This also helps the user, in particular, in finding content assigned to the graphical user interface.

In general, content can also be found through the global search that the user may not have been aware of. By way of example, it is possible that speaker settings can be set via numerous independent services, such as a music playback service, but also via configuration options for the graphical user interface. These can be displayed collectively to a user as search results with the approach presented herein. The user therefore obtains a quick overview of all of the content in the driver information system, regardless of the service where it is contained, and in particular regardless of whether this content is contained in the graphical user interface itself.

In some examples, a driver information system is disclosed for a vehicle that includes a display unit (such as a display device with a touch-sensitive surface), with which a (preferably graphical) user interface can be displayed, wherein the (preferably graphical) user interface includes (virtual) links to services, wherein the services can be displayed by actuating an associated link on the display unit, and wherein the driver information system includes a main search function that is configured to obtain results (from and/or in and/or via) both the (preferably graphical) user interface, as well as the services, in response to a search input.

The present disclosure also relates to a method for searching through a driver information system in a vehicle, wherein the driver information system includes a display unit with which a graphical user interface can be displayed, and wherein the method comprises:
displaying links to services with or in the graphical user interface, wherein the services can be displayed by actuating an associated link on the display unit; and
providing a main search function that is configured to send search results to both the graphical user interface and the services in accordance with a search input.

The method can include all further features, functions, and developments for providing all of the operating states, interactions, and effects according to the present disclosure described herein. In particular, the method can likewise include all of the variations and developments of the same features of the driver information system.

### BRIEF DESCRIPTION OF THE DRAWINGS

The present disclosure shall be explained below in reference to the attached, schematic figures. Therein:

FIG. 1 shows a simplified functional illustration of a driver information system according to an exemplary embodiment of the present disclosure; and

FIG. 2 shows a flow chart for a method according to the present disclosure, which can be executed with the driver information system shown in FIG. 1 under aspects of the present disclosure.

### DETAILED DESCRIPTION

As disclosed herein, a graphical user interface can be configured as a work surface, and/or a service, that may include the start-up screen for the driver information system. A user can access a menu structure via the graphical user interface in the known manner, and navigate therein, to access various content and functions in the driver information system, and in particular to activate services in the driver information system.

In general, any state or content (e.g., in the form of a screenshot) that can be displayed can be referred to as a displayable screen. Depending on the navigational state within the menu structure for the user interface, various screens can be displayed, i.e., the graphical user interface can include numerous screens in general. The aforementioned links to the services can be provided in at least one of these screens. Content or submenu structures that can be accessed within the user interface, for example, can be displayed via other screens, such as a configuration menu for various vehicle functions (e.g., for an interior lighting or loudspeaker system).

In some examples, the graphical user interface can be a tangibly embodied software component or software application. The services themselves can likewise be software components or software applications. Both the graphical user interface and the services can be executed by a processor in the driver information system. The processor can include at least one microprocessor. By executing the program instructions defined within these software components, the driver information system can provide and execute the functions specified therein, the operating states, and in particular the display states, in conjunction with the services and the graphical user interface.

The links can be provided in the form of symbols or icons. Alternatively or additionally, the links can be in a text form, or include textual information, that indicates the services that can be accessed via the link.

It should be noted that the term, “graphical user interface” as used herein does not necessarily mean that the user interface is limited to just graphical interactions. Instead, it can be a general user interface, which, aside from, e.g., a graphical work surface, is also configured to receive acoustic input (e.g., speech input), or output speech information or general audio signals. It can therefore be a user interface that includes graphical displays of screens, but can also interact with a user in other ways (in particular acoustically).

In general, the links do not necessarily have to be links that can be displayed graphically. Instead, these can be links that can be activated by a speech input. These links can be stored in a speech recognition system, for example, and activated when a corresponding speech input is identified.

In some examples, services can be displayed, as a result of the actuation of an associated link, exclusively (i.e., occupying the entire surface area of the display), or as the foreground and/or primary window within the display. Services can also be accessed and/or operated in the known manner in parallel, such that it is possible to toggle between the display windows for these services. In this case, the graphical user interface, and/or at least one screen thereon, preferably from the lowest window.

The main search function can be a service of the type specified herein, generally, as a software component that can be accessed by the driver information system. The main search function may be configured in general to obtain search results from or in numerous services, and preferably within all of the services in the driver information system, including the user interface. A (search) string can be compared with strings within the data collections in the corresponding services (and in particular the graphical user interface) in the known manner, to find results. When the results match sufficiently, the matching data can be identified.

As is explained below, the main search function can obtain results directly (e.g., through the comparison described above). For some services, it can also obtain results indirectly, or from search functions that contain these services (e.g., in that they obtain the relevant string as a search function for the service, and then receive the results therefrom, without having to make the comparison specified above themselves).

More precisely, the main search function obtains the results for the service according to a further development by means of search functions for these services. Navigation services and music playback services may already include search functions that enable searches within data or data collections assigned to them. Instead of accessing these data collections directly for the individual services, the main search function can merely provide information regarding the search input (e.g., a string) to the search functions for this service. These search functions can then search for results themselves within the data collections for the service, and then send the results back to the main search function.

In some examples, the main search function can provide a search string to the search function for at least one of the services, and obtain results from (or by and/or via and/or within) this search function for this service.

In some examples, the main search function is configured to search the graphical user interface for results. This can be, in particular, an active and/or direct search through the graphical user interface by the main search function. In other words, the main search function can be configured to make comparisons itself between a search input and/or search string, and data assigned by the graphical user interface or a data collection from this graphical user interface.

In general, the main search function can therefore also be configured to search through results from the graphical user interface itself, preferably without accessing other search functions. This is advantageous in that the graphical user interface itself does not need to include a search function (although this would not be counter to the framework of the present disclosure), but can also be supplemented by a corresponding search function by means of the main search function, which can also be a service itself.

In reference to at least one further service, in which the main search function accesses a search function in this service, the main search function can therefore be a meta-search function. In reference to the graphical user interface, the main search function, however, is preferably a direct search function for this graphical user interface, or provides such a direct search function.

In some examples, the search input can be entered by a user, and the main search function is configured to obtain a search string on the basis of the search input, based on which the results are obtained. According to another embodiment, the search input can be entered in the form of a text, input by handwriting (e.g., by moving a fingertip on a touch-sensitive surface) or through speech.

In some examples, the main search function can therefore convert search inputs into an appropriate search string. The search string can be a text string in general. Accordingly, the main search function can enable a so-called speech-to-text conversion if the search input takes place in text form. The main search function can also enable handwriting recognition, if the search input is entered in handwriting, and compose the search string, e.g., from recognized letters in the handwritten input. A keyboard, or so-called soft keyboard, can be used enter searches in text form, which is preferably displayed on the display unit when needed.

These variations have the advantage that the main search function already creates suitable search strings, and can then forward these to at least one search function in another service. As a result, relevant functions can be bundled within the main search function for the global search according to the present disclosure, like the corresponding conversion of a search input into a suitable (search) string, such that the other services do not need to be adapted, or only need be adapted slightly, for the desired global search. This increases the flexibility of the driver information system, e.g., if new services need to be supplemented, or in general, if these services in the driver information system need to be able to be configured in a flexible manner, and/or be replaceable.

The main search function can include an interface for exchanging information with the services. The interface can be a program interface, or a software interface, respectively. The services preferably include corresponding interfaces. In particular, the interfaces can be configured such that an exchange of information is enabled with services in the driver information system that can be configured in a flexible manner, or are replaceable, increasing the flexibility. In particular, the services can connect via these interfaces to the main search function in the framework of a start-up process, or become known thereto, such that they can be searched for relevant content (or include a search function that can be accessed by the main search function). The main search function can then access the corresponding service via the interface in response to a search input, without the necessity of further configuration. Results from the services can be sent to the main search function in the framework of the information exchange enabled via the interface, and/or the aforementioned search string can be sent from the main search function to the service.

In some examples, the main search function may be configured to generate a list of results containing search results, wherein the search results are sorted according to relevance. This list of results can be displayed on the display unit. In particular, they can be displayed during a search input, e.g., before the search input is complete (e.g., before any complete term or word has been entered by the user). In particular in the case of a speech input, it is also possible to first display the result list after a search input has been entered. It is still possible to continuously update the results in this case, if the services first provide the results successively.

The sorting according to relevance can take place in that the search results each include relevance data. This is preferably standardized, and therefore independent of the service from which a search result is obtained. By way of example, the relevance data can be an evaluation value (e.g., a relevance score).

In this context, the relevance data for the search result can also be obtained from the search function in the service. This also reduces the demands on the main search function, or simplifies the structure of the system. More precisely, this embodiment makes use of the fact that the search functions in the services are already configured to determine corresponding relevance data. Accordingly, the relevance data can be sent along with the search results from the services to the main search function.

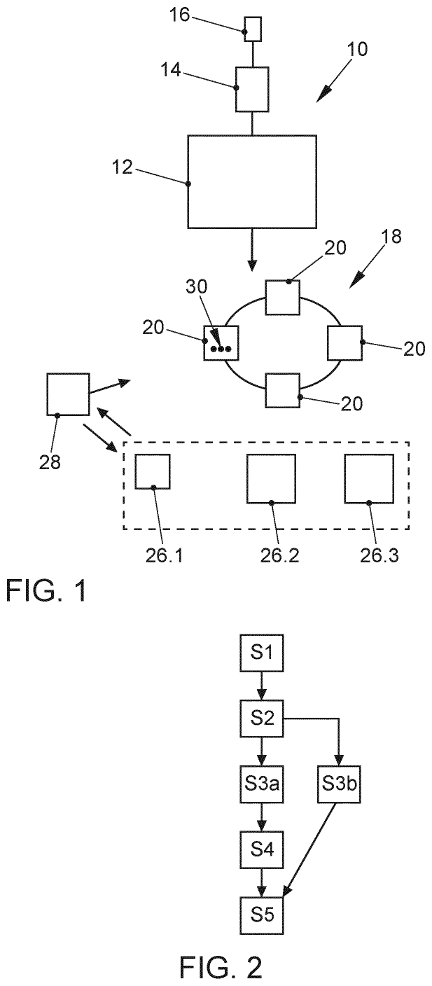

Turning to FIG. 1, a driver information system 10 is illustrated, wherein functions that can be executed therewith are primarily visualized, and not mainly hardware components actually included therein. The driver information system 10 includes a display unit 12, which is preferably a touch-sensitive screen (e.g., a touchscreen), as a hardware component. This is installed in a vehicle, not shown, in particular a passenger automobile. The display unit 12 can be incorporated in a central panel or dashboard in the known manner.

The driver information system 10 also includes a processor 14 that has at least one microprocessor. The processor 14 is connected to a memory 16 in the driver information system 10. Data, and in particular software components, are stored in the memory 16, each of which provide services of the driver information system 10 that can be accessed by a user when the software components are executed on the processor 14. Display content for the display unit 12 can then be obtained in the known manner, in which interaction between user inputs and defined display content is possible in general, and/or the display content can be determined by the user inputs.

A graphical user interface 18 can be displayed on the display unit 12 as a fundamental function of the driver information system 10. This includes numerous screens in the known manner, which are shown in simplified version in FIG. 1, and given the reference symbol 20. Individual screens 20 are shown on the display unit 12 in accordance with the user input (e.g., touchscreen input or speech input). The screens 20 can each include input fields and/or specific information according to the user inputs that are received. The screens 20, which can also be referred to in general as “views,” are structured in accordance with a menu structure for the graphical user interface 18. The screens 20 are displayed on the display unit based on how a user navigates this menu structure by means of corresponding user input.

The graphical user interface 18 is also stored as an executable software component in the memory 16. The services 26.1-26.3 and a main search function 28, which is also a service, may also be stored as software components therein. As explained herein, these services 26.1-26.3 may also be in the form of software components or software applications, and can provide relevant specific functions for a user.

In this example, service 26.1 is a navigation service, service 26.2 is a music playback service, and service 26.3 is a service for controlling the vehicle's climate control system. Examples of other services are a (digital) vehicle owner's manual, a radio service, a (digital) address book, or a (digital) media collection. In general, any other type of service can also be provided, and the services can be configured in a flexible manner, and in particular be exchangeable, e.g., prior to delivering the driver information system 10, or subsequently, by the vehicle owner.

The services 26.1-26.3 can be accessed via links 30, preferably in the form of symbols and/or icons, and displayed in at least one of the screens 20 in the graphical user interface 18. By selecting the appropriate link (e.g., through a corresponding touch-input), the associated service 26.1-26.3 is accessed, and preferably shown on the display unit 12 in place of, or superimposed on, one of the screens 20 in the graphical user interface 18, at least in part, and preferably over most of it. The main search function 28 can be accessed via a corresponding link 30. Alternatively or additionally, the main search function 28 (or a link 30 thereto) can be permanently shown in all of the screens 20 on the graphical user interface 18, or at least in a majority thereof.

A search input can be entered when the main search function 20 is accessed. In particular, this involves displaying a text input field in which a search term or, in more general terms, a search string, can be entered with a keyboard or using a handwriting input system. The search input can also take place with a speech input, wherein a search string can then be displayed in the search field that is generated or converted from the speech input.

The main search function 28 may be configured to search through numerous services 26.1-26.3, including the graphical user interface 18. More precisely, the main search function 28 can obtain results from all of the data assigned to the individual services 26.1-26.3, as well as the graphical user interface 18.

In this example, the main search function 28 may search through the graphical user interface 18 directly for results in that it searches through a data collection (e.g., stored in the memory 16) belonging to the graphical user interface 18 itself. It does this by comparing a search string that it receives, or has been sent, with entries in the data base. The results can be text fields or general test strings, which are displayed in the known manner in one of the views 20 on the graphical user interface 18. These text fields can indicate input options or relate to displayed information (e.g., temperatures, etc.). If, for example, a user enters an ambient temperature as the search input, the main search function can determine that a display field with a corresponding name exists in one of the views 20 in the graphical user interface 18, and identify it as the relevant search result.

The main search function does not execute any autonomous or direct search with regard to the services 26.1-26.3. Instead, it forwards the search string to the services 26.1-26.3, and more precisely to search functions included in these services 26.1-26.3. These can be conventional search functions, in which the user can enter search inputs in the manner described above when accessing the services 26.1-26.3, e.g., in an address field in the navigation service 26.1, or a music title search field in the music playback service 26.2. This functionality is provided in the present case by the main search function 28, which accesses their search functions without having to access the services 26.1-26.3 directly, or show them on the display unit 12, and sends the received or sent search string thereto. The services 26.1-26.3 then execute an independent search by means of their respective search functions for relevant search results, wherein they access their own data collections.

These data collections can be data collections in these services 26.1-26.3 stored in the memory 16. These can also be data that can be accessed by the services 26.1-26.3 online (i.e., so-called “online data”). Collectively, the data collections for a service 26.1-26.3 can be data that are permanently stored or accessible online in the framework of this disclosure, that are assigned to a corresponding service and/or can be accessed by the service, and in particular by a search function thereof, for example.

The services 26.1-26.3 each obtain relevant results and send them to the main search function 28.

The information exchange is indicated in FIG. 1 by arrows, wherein the services 26.1-26.3 are grouped together in a simplified manner according to the broken outline, and arrows are not necessarily shown for each of the services 26.1-26.3. It is schematically shown that the main search function 28 and the services 26.1-26.3 exchange information, because the search strings are sent from the main search function 28 to the services 26.1-26.3, or their search functions, and they then return relevant search results.

A comparable information exchange in a narrower sense does not take place with regard to the graphical user interface 18 however, because the main search function 28 carries out an autonomous search here, and the graphical user interface 18 does not provide its own search function (which would, however, also be possible according to the present disclosure). Accordingly, only one arrow is shown between these units 28, 18 in this case, indicating that the main search function 28 actively searches through the graphical user interface 18, and obtains search results therein itself.

On the whole, the main search function 28 can therefore access data from all of the services 26.1-26.3, as well as the graphical user interface 18, and thus create a comprehensive list of all of the relevant search results, and display them to a user. The user can then select a relevant result, depending on the service 26.1-26.3, or the screen 20 in the graphical user interface 18, from which it comes, switch directly to a corresponding screen 20 shown on the display unit 12, or a service 26.1-26.3.

The method explained above shall be summarized below in reference to FIG. 2. A user enters a search input in the driver information system 10 in an arbitrary manner in the first step S1. The main search function 28 then obtains a search string from this search input for which search results are to be obtained in the second step S2. This can include conversion of a speech input to a text string, for example. The main search function 28 sends the search string to the search functions in the individual services 26.1-26.3, preferably via a software interface, not shown, in the next step S3a. The main search function 28 searches through the data belonging to the graphical user interface 18 for relevant search results in another step S3b, which can preferably be carried out simultaneously with step S3a, or immediately before or after it. The individual search functions in these services 26.1-26.3 preferably simultaneously search through the respective data that can be accessed by these services 26.1-26.3, or are assigned thereto, for relevant search results (step S4). All of the search results that are obtained are compiled in a list of results in a subsequent step S5, and displayed on the display unit 12. This can also take place in parallel to steps S3b and S4, i.e. the result list can be updated continuously by the respective search results that are obtained.

### LIST OF REFERENCE SYMBOLS

10 driver information system
12 display unit
14 processor
16 memory
18 graphical user interface
20 screen
26.1-26.3 service
28 main search function
30 link

1-10. (canceled)

11. A driver information system, comprising:
a memory; and
a processor, operatively coupled to the memory; and
a display unit, operatively coupled to the processor, wherein the processor and display unit are configured to
generate a graphical user interface (GUI), wherein the GUI comprises links to vehicle services, configured to execute a vehicle function when activated, and
generate a main search function that is configured to obtain search results for a search input in both the GUI and the links to vehicle services.

12. The driver information system of claim 11, wherein the main search function is configured to obtain the search results from at least one of the vehicle services via a search function associated with each the vehicle services.

13. The driver information system of claim 12, wherein the main search function is configured to forward a search string to the search function in the at least one vehicle service and receive search results from the search function in the at least one vehicle service.

14. The driver information system of claim 11, wherein the main search function is configured to search through the graphical user interface for the search results.

15. The driver information system of claim 11, wherein the main search function comprises an interface for information exchange with the vehicle services.

16. The driver information system of claim 11, wherein the main search function is configured to generate a list of search results, wherein the search results are sorted according to relevance.

17. The driver information system of claim 16, wherein the relevance for at least one of the search results is obtained from the search function of one of the vehicle services.

18. A method for operating a driver information system, comprising:
generating, via a display unit, a graphical user interface (GUI), wherein the GUI comprises links to vehicle services, configured to execute a vehicle function when activated; and
executing, vi a processor, a main search function that is configured to obtain search results for a search input in both the GUI and the links to vehicle services.

19. The method of claim 18, wherein the main search function is configured to obtain the search results from at least one of the vehicle services via a search function associated with each the vehicle services.

20. The method of claim 19, wherein the main search function is configured to forward a search string to the search function in the at least one vehicle service and receive search results from the search function in the at least one vehicle service.

21. The method of claim 18, wherein the main search function is configured to search through the graphical user interface for the search results.

22. The method of claim 18, wherein the main search function comprises an interface for information exchange with the vehicle services.

23. The method of claim 18, wherein the main search function is configured to generate a list of search results, wherein the search results are sorted according to relevance.

24. The method of claim 23, wherein the relevance for at least one of the search results is obtained from the search function of one of the vehicle services.

25. A computer-readable medium having stored therein instructions executable by one or more processors for operating a driver information system, to:
generate a graphical user interface (GUI), wherein the GUI comprises links to vehicle services, configured to execute a vehicle function when activated, and
generate a main search function that is configured to obtain search results for a search input in both the GUI and the links to vehicle services.

26. The computer-readable medium of claim 25, wherein the main search function is configured to obtain the search results from at least one of the vehicle services via a search function associated with each the vehicle services.

27. The computer-readable medium of claim 26, wherein the main search function is configured to forward a search string to the search function in the at least one vehicle service and receive search results from the search function in the at least one vehicle service.

28. The computer-readable medium of claim 25, wherein the main search function is configured to search through the graphical user interface for the search results.

29. The computer-readable medium of claim 25, wherein the main search function comprises an interface for information exchange with the vehicle services.

30. The computer-readable medium of claim 25, wherein the main search function is configured to obtain the search results from at least one of the vehicle services via a search function associated with each the vehicle services.
